(19) United States
(12) Patent Application Publication
(10) Pub. No.: US 2019/0213659 A1
(43) Pub. Date: Jul. 11, 2019

(54) INTERACTION INTELLIGENCE ENGINE FOR COMMUNICATION ENHANCEMENT AND FULFILLMENT

(71) Applicant: BANK OF AMERICA CORPORATION, Charlotte, NC (US)

(72) Inventors: Stephen Shannon, Charlotte, NC (US); Anthony Pang Fang, Coppell, TX (US); John Lilley, Charlotte, NC (US); Teron Wayne Douglas, Roswell, GA (US); James DeBois, Huntington, NY (US); James Alexander, Dripping Springs, TX (US)

(21) Appl. No.: 15/864,505

(22) Filed: Jan. 8, 2018

(51) Int. Cl. G06Q 30/06; G10L 15/16; G10L 15/18; G10L 15/22

(52) U.S. Cl. CPC G06Q 30/0631; G10L 15/16; G10L 2015/223; G10L 15/22; G10L 15/1815

(57) ABSTRACT

Embodiments of the invention are directed to a system, method, or computer program product for an interaction intelligence engine for communication enhancement and fulfillment. The engine identifies a user and associate initiation of a communication at an entity location. The engine identifies the authentication of a user by an entity associate. In some embodiments, the engine is triggered for conversation assistants and enhancement. In this way, the system identifies user needs based on conversational analysis and cues. In some embodiments, the engine provides fulfillment improvement and assistance. In this way, the system initiates the pertinent product documentation, account opening, application process, or the like and pre-fill necessary data fields when the system hears conversational cues that indicative of documentation requirements.

### BACKGROUND

Users typically have a variety of options when communicating with entities. A user may have one or more ways he/she prefers to communicate with the entity, such as calling the entity, online, mobile, or at a brink-and-mortar location. When a user communicates with an entity, the entity wants to assist that user as quickly as possible. As such, providing fast, accurate user service to the user when the user communicates with the entity.

### BRIEF SUMMARY

Embodiments of the present invention address the above needs and/or achieve other advantages by providing apparatuses (e.g., a system, computer program product and/or other devices) and methods for providing an interaction intelligence engine for communication enhancement and fulfillment for user communication with an entity.

A user may wish to communicate with an entity. The user communication may be for one or more reasons such as to complete a transaction, conduct business, a question, a dispute, sign up for or apply for a product or server, or the like. Furthermore, the user may be able to communicate with the entity via several different means or channels of communication. These may include online or offline communication channels. Online communication channels may include one or more of communications via a website, application, chatting, email, or the like. Offline communication channels may include the user going to a store location, an automated teller machine (ATM), or the like. With several different locations and channels for a user to communicate with the entity, it is important that the entity monitors and knows why the user has communicated with the entity in the past. As such, this invention provides an agent communication aid that is based on a user context analysis, this way the agent or channel may be in a better position to provide user service upon user communications.

Furthermore, when users come to a brink-and-mortar or physical location entity associates face three challenges in the process of interacting with sit-down users. The first challenge is to offer helpful product solutions based on the user's needs without suggesting an inappropriate product or missing opportunities to offer products that could help the user. The second challenge is for the associate to smoothly interact with the user while frequently looking at and typing into the computer to access and input important information that helps the associate during the interaction. This multitasking is difficult, time consuming, disrupts the flow of conversation, and can often appear awkward to the user. The third challenge is to initiate and complete the account opening or application process accurately and quickly. The process often requires significant data entry which is prone to error, and time consuming. Errors cost users and entities time and energy to remedy, and every minute spent doing data entry is a minute the associate could be interacting more fully with the current user customer or helping the next user waiting. As such, one of the biggest challenges for associates at an entity physical location is reducing lobby wait time for users with appointments and walk-ins. In addition, the faster an account opening interaction is completed, the more amenable a user will be to agree to a referral.

The interaction intelligence engine for communication enhancement and fulfillment comprises an artificial intelligence engine (running on a tablet, standalone device, or laptop/desktop computer) with the capability to listen to the associate-user conversation, analyze the conversation in real-time (without saving or recording) and perform helpful actions based on what is heard.

In some embodiments, the interaction intelligence engine provides conversation assistants and enhancement. In this way, the system identifies user needs based on conversational analysis and cues, and suggest appropriate products that might help the user. The system also makes suggestions to the associate about what direction to take the conversation, such as asking a question or diving deeper into a particular area of user need. This would aid the associate in identifying user needs and offering appropriate product solutions, while reducing missed opportunities and inappropriate product offers. It would also reduce the associate's need to interact with (look at, type into, navigate) a computer or associate system during the conversation with the user, eliminating much of the physical and mental multi-tasking associates currently must do to find pertinent information about the user, analyze it, and decide what products to offer, all while trying to carry on a conversation. The system replaces much or all of this associate multitasking work, by intelligently analyzing the conversation and offering pertinent information, suggestions, and product offers “verbally” or on screen.

In some embodiments, the interaction intelligence engine provides fulfillment improvement and assistance. In this way, the system initiates the pertinent product documentation, account opening, application process, or the like and pre-fill necessary data fields when the system hears conversational cues that indicate this is what the user wants to do. This would decrease data entry mistakes, increase accuracy and thoroughness, and save both the associate and the user time while making their interaction smoother. It would also reduce lobby wait time for other users with appointments or walk-ins, produce better appointment handling with an improved user appointment experience, and reduce the stress and logistical problems of the physical location of the entity.

In some embodiments, the invention provides information to the associate about talking points and/or products/services for the associate to present to the user for review. In this way, the invention provides a real-time updated training tool for associates to identify key triggers of user information trigging potential products/services for the user to consider. As such, the system provides a training system for associate solo training and experience valuation in real-time during user interaction at a financial institution allowing associates to learn the products/services for user presentation based on user needs and requirements, providing a holistic financial view for the user.

In some embodiments, the invention provides an improvement to financial services for users. As such, during communications between users and associates, the system may be able to trigger presentation of the exact products/services for the user. As such, when hearing complex user financial requirements, the system may be able to aid associate discussion about the proper subject and implement correct tools for satisfactory customer service.

In some embodiments, the invention allows for customer service in a volume heavy entity industry. In this way, the system allows for product/service determinations that are similar across a large entity with millions of user associate interactions in a day. As such, the invention allows for tracking of data and maintaining continuity across a large volume of users each day for product and service provisioning.

Embodiments of the invention relate to systems, methods, and computer program products for communication enhancement and fulfillment, the invention comprising: identifying a user in communication with an associate; triggering presentation of a user profile associated with the user to the associate, wherein the presentation of the user profile is triggered based on the identification of the user in communication with the associate; performing real-time conversation monitoring of user and associate conversation; analyzing segments of conversation for sentiment and intent, wherein upon analysis the segments of the conversation are discarded and not stored; identifying one or more products/services for the user based on the sentiment and intent of the user via analyzing of the segments of the conversation; deploying, in real-time, the one or more products/services identified to the associate via the user profile, for associate presentation of the one or more products/services to the user; confirming user interest in the one or more products/services for the user; and extracting and pre-populating documents associated with sign up for the one or more products/services for the user and present the pre-populated documents to the associate.

In some embodiments, extracting and pre-populating documents associated with sign up for the one or more products/services for the user further comprises utilizing the segments of the conversation and the user profile for pre-populating documents for error prevention of document generation.

In some embodiments, the invention further comprises presenting the one or more products/services to the associate for communication of the one or more products/services to the user and identifying the outcome of the presenting of the one or more products/services for adjustment of inductive logic for analyzing of the segments of the conversation.

In some embodiments, identifying one or more products/services for the user based on the sentiment and intent of the user via analyzing of the segments of the conversation further comprises identifying one or more products/services the user is intending to sign up for and identifying one or more products/services that are predicted for the user based on the sentiment and intent of the user via analyzing of the segments of the conversation and the user profile.

In some embodiments, identifying the user in communication with the associate further comprises identifying the user at a physical location of an entity in communication with the associate.

In some embodiments, identifying the user in communication with the associate further comprises authenticating the user at an entity location.

In some embodiments, presenting the user profile to the associate further comprises authenticating the user associated with the user profile prior to presenting the user profile to the associate, the authentication occurs via geo-fence identification, personal identification number (PIN), magnetic strip swiping of financial institution card, or password authentication, wherein the user profile provides an interface which includes information about recent user events, accounts the user has with an entity, products/services available to the user from the entity, user status information, and entity solutions for the user communications.

In some embodiments, the user profile is adapted to be presented to the agent at a communication channel associated with an entity, when the user communicates with the associate, such that the associate has immediate access to information about the user via the user profile.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides an interaction intelligence engine system environment, in accordance with one embodiment of the present invention;

FIG. 2 provides a high level process flow illustrating interaction intelligence engine triggering for communication enhancement, in accordance with one embodiment of the present invention;

FIG. 3 provides a continuum mapping for product/service identification for communication enhancement, in accordance with one embodiment of the present invention;

FIG. 4 provides a high level process flow illustrating interaction intelligence engine triggering for product/service document fulfillment, in accordance with one embodiment of the present invention;

FIG. 5 provides a process map illustrating interaction intelligence engine triggering for communication enhancement and fulfillment, in accordance with one embodiment of the present invention; and

FIG. 6 illustrates an embodiment of a user profile, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

In some embodiments, an “entity” may be a financial institution, business, or the like that may have associates that may desire to transmit information outside the entity. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. An “account” may be the relationship that the user has with the entity. Examples of accounts include a deposit account, such as a transactional account (e.g., a banking account), a savings account, an investment account, a money market account, a time deposit, a demand deposit, a pre-paid account, a credit account, a non-monetary user profile that includes only personal information associated with the user, or the like. The account is associated with and/or maintained by the entity. In other embodiments, an entity may not be a financial institution. In still other embodiments, the entity may be the merchant itself.

For the purposes of this invention, a “communication” or a “user communication” may be any physical conversation at a physical entity location. Alternatively a communication may be a digital or electronic transmission of data, metadata, files, or the like. The communication may be originated by an individual, application, system within an entity. Furthermore, an “external party” may be one or more individuals, entities, systems, servers, or the like external to the entity. This may include third parties, partners, subsidiaries, or the like of the entity.

Although some embodiments of the invention herein are generally described as involving an entity or “financial institution,” one of ordinary skill in the art will appreciate that other embodiments of the invention may involve other businesses that take the place of or work in conjunction with the financial institution to perform one or more of the processes or steps described herein as being performed by a financial institution. Still in other embodiments of the invention the financial institution described herein may be replaced with other types of businesses that agent communications aids.

Some portions of this disclosure are written in terms of a financial institution's unique position with respect to user transactions. As such, a financial institution may be able to utilize its unique position to receive, store, process, retrieve, and present information associated with user transactions and user communications.

The embodiments described herein may refer to the term associate. An associate may include one or more individuals associated with an entity that a user may communicate with. This agent may be a bank teller, a user service representative, other employee, partner, or the like associated with the entity. Furthermore, a “channel” as used herein may be one or more ways in which a user may communicate with an entity, such as a financial institution. These channels may include one or more of online or offline channels. Online channels may include applications, clouds, web sites, mobile applications, ATMs, or the like. Offline channels may include store locations, drive through locations, or the like.

When users come to a physical location entity associates face three challenges in the process of interacting with sit-down users. The first challenge is to offer helpful product solutions based on the user's needs without suggesting an inappropriate product or missing opportunities to offer products that could help the user. The second challenge is for the associate to smoothly interact with the user while frequently looking at and typing into the computer to access and input important information that helps the associate during the interaction. This multitasking is difficult, time consuming, disrupts the flow of conversation, and can often appear awkward to the user. The third challenge is to initiate and complete the account opening or application process accurately and quickly. The process often requires significant data entry which is prone to error, and time consuming. Errors cost users and entities time and energy to remedy, and every minute spent doing data entry is a minute the associate could be interacting more fully with the current user customer or helping the next user waiting. As such, one of the biggest challenges for associates at an entity physical location is reducing lobby wait time for users with appointments and walk-ins. In addition, the faster an account opening interaction is completed, the more amenable a user will be to agree to a referral.

The interaction intelligence engine for communication enhancement and fulfillment comprises an artificial intelligence engine (running on a tablet, standalone device, or laptop/desktop computer) with the capability to listen to the associate-user conversation, analyze the conversation in real-time (without saving or recording) and perform helpful actions based on what is heard.

In some embodiments, the interaction intelligence engine provides conversation assistants and enhancement. In this way, the system identifies user needs based on conversational analysis and cues, and suggest appropriate products that might help the user. The system also makes suggestions to the associate about what direction to take the conversation, such as asking a question or diving deeper into a particular area of user need. This would aid the associate in identifying user needs and offering appropriate product solutions, while reducing missed opportunities and inappropriate product offers. It would also reduce the associate's need to interact with (look at, type into, navigate) a computer or associate system during the conversation with the user, eliminating much of the physical and mental multi-tasking associates currently must do to find pertinent information about the user, analyze it, and decide what products to offer, all while trying to carry on a conversation. The system replaces much or all of this associate multitasking work, by intelligently analyzing the conversation and offering pertinent information, suggestions, and product offers “verbally” or on screen.

In some embodiments, the interaction intelligence engine provides fulfillment improvement and assistance. In this way, the system initiates the pertinent product documentation, account opening, application process, or the like and pre-fill necessary data fields when the system hears conversational cues that indicate this is what the user wants to do. This would decrease data entry mistakes, increase accuracy and thoroughness, and save both the associate and the user time while making their interaction smoother. It would also reduce lobby wait time for other users with appointments or walk-ins, produce better appointment handling with an improved user appointment experience, and reduce the stress and logistical problems of the physical location of the entity.

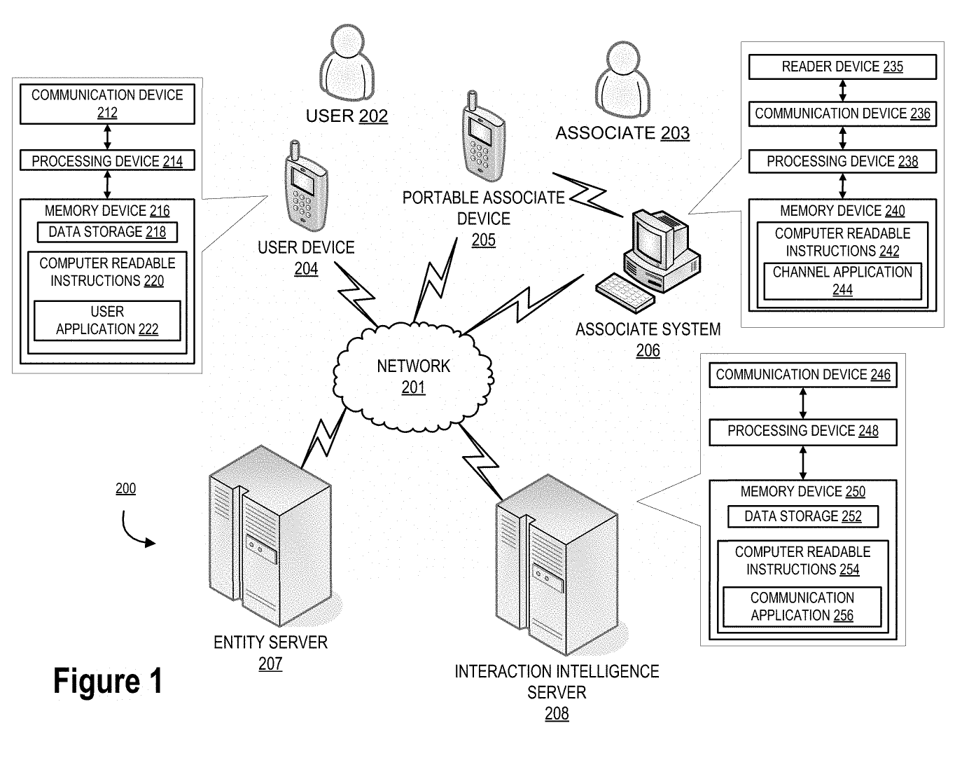

FIG. 1 provides in interaction intelligence engine system environment 200, in accordance with one embodiment of the present invention. As illustrated in FIG. 1, the interaction intelligence server 208 is operatively coupled, via a network 201 to the user device 204, entity server 207, the portable associate device 205, and to the associate system 206. In this way, the interaction intelligence server 208 can send information to and receive information from the user device 204, entity server 207, portable associate device 205, and the associate system 206. FIG. 1 illustrates only one example of an embodiment of the system environment 200, and it will be appreciated that in other embodiments one or more of the systems, devices, or servers may be combined into a single system, device, or server, or be made up of multiple systems, devices, or servers.

The network 201 may be a global area network (GAN), such as the Internet, a wide area network (WAN), a local area network (LAN), or any other type of network or combination of networks. The network 201 may provide for wireline, wireless, or a combination wireline and wireless communication between devices on the network 201.

In some embodiments, the user 202 is an individual communication with an entity. The communication may be via one or more channels associated with the financial institution or entity. In some embodiments, the communication may be with an entity associate at a physical location of the entity. As such, the communication may be made at or through an associate system 206 associated with the financial institution. Other channels for the communication with the entity may include one or more online websites, mobile applications, online applications, over the phone, ATM, or the like.

In some embodiments, the communication may be in person. The user 202 may also have a user device 204. The user device 204 may include a mobile device (i.e. smart phone, PDA, and the like) or other types of systems that communicate with other systems on the network 201, such as the associate system 206, portable associate device 205, entity server 207, and/or interaction intelligence servers 208. In some embodiments of the invention, the user 202 may communicate with the entity using his/her user device 204.

FIG. 1 also illustrates a user device 204. The user device 204 generally comprises a communication device 212, a processing device 214, and a memory device 216. The user device 204 is a computing system that allows a user 202 to communicate with the entity and enter into transactions both via a network 201. The processing device 214 is operatively coupled to the communication device 212 and the memory device 216. The processing device 214 uses the communication device 212 to communicate with the network 201 and other devices on the network 201, such as, but not limited to the associate system 206, entity server 207, and the interaction intelligence server 208. As such, the communication device 212 generally comprises a modem, server, or other device for communicating with other devices on the network 201. The user device 204 comprises computer-readable instructions 220 and data storage 218 stored in the memory device 216, which in one embodiment includes the computer-readable instructions 220 of a user application 222. The user device 204 may be, for example, a desktop personal computer, a mobile system, such as a cellular phone, smart phone, personal data assistant (PDA), laptop, or the like. Although only a single user device 204 is depicted in FIG. 1, the system environment 200 may contain numerous user devices 204.

As further illustrated in FIG. 1, the interaction intelligence server 208 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the associate system 206, entity server 207, and the user device 204. As such, the communication device 246 generally comprises a modem, server, or other device for communicating with other devices on the network 201.

As further illustrated in FIG. 1, the interaction intelligence server 208 comprises computer-readable instructions 254 stored in the memory device 250, which in one embodiment includes the computer-readable instructions 254 of a communication application 256. In some embodiments, the memory device 250 includes data storage 252 for storing data related to the data created and/or used by the communication application 256.

In the embodiment illustrated in FIG. 1 and described throughout much of this specification, the communication application 256 has the capability to listen to the associate-user conversation, analyze the conversation in real-time (without saving or recording) and perform helpful actions based on what is heard.

In some embodiments, the communication application 256 provides conversation assistants and enhancement. In this way, the communication application 256 identifies user needs based on conversational analysis and cues, and suggest appropriate products that might help the user. The communication application 256 also makes suggestions to the associate about what direction to take the conversation, such as asking a question or diving deeper into a particular area of user need.

In some embodiments, the communication application 256 provides fulfillment improvement and assistance. In this way, the communication application 256 initiates the pertinent product documentation, account opening, application process, or the like and pre-fill necessary data fields when the system hears conversational cues that indicate this is what the user wants to do.

In some embodiments, the communication application 256 processes the user voice or action data being generated during a user interaction with an associate at the entity. The processing is done in real-time as the user event data is received by the communication application 256. The processing via the processing device 248 may take all of the various user data. The processing includes logic, rules, algorithms, and intelligence to process the data. The processing includes user context analysis of the user conversation and actions. The processing determines or predicts what the user 202 would like completed during his/her communication. As such, a probability tool is incorporated based on modeling and prior experiences into the communication application 256. Furthermore, the communication application 256 also stores dispositions associated with recent user 202 communications in the memory device 250

In some embodiments, the communication application 256 predicts one or more reasons why the user may attempt to communicate with the entity in the future. This allows the communication application 256 to prepare the communication channel for user 202 interaction and allows for improved user service. Predicting one or more reasons why the user will be communicating with the entity in the future is determined by event data collected from above.

In some embodiments, the communication application 256 modulates communications directs future user communications such that they may be impactful and useful. As such, the communication application 256 may modulate the communications channel for each future communication. As such, the communication application 256 may develop and/or present a user 202 with a different interface via an online channel the next time the user 202 logs on to his/her online or mobile banking. This interface may present the user 202 with one or more indicators, models, offers, promotions, answers, or the like that are predicted to be why the user 202 is logging into his/her online or mobile banking application. In this way, the system may modulate communications with the user 202 to provide more impactful user relations and user service.

As illustrated in FIG. 1, the associate system 206 is associated with the associate at the entity channel that the user 202 is communication with. As such, the user 202 may be able to communicate with the entity via several different means or channels. These may include online or offline communication channels. Online communications may include one or more of communications via a website, application, chatting, email, or the like that may occur over a network 201. Offline communication channels may include the user going to a store location, an ATM, or the like. The associate system 206 generally comprises a reading device 235, a communication device 236, a processing device 238, and a memory device 240. The reading device 235 is operatively coupled to the processing device 238, communication device 236, and the memory device 240. The associate system 206 may include a reader device 235 to receive authentication of user 202 access to his/her accounts at the financial institution. Such a reader device 235 may include a magnetic strip reader, a barcode scanner, a radio frequency (RF) reader, a character recognition device, a magnetic ink reader, a processor for interpreting codes presented over an electrical or optical medium, a biometric reader, a wireless receiving device, and/or the like. In some embodiments, the reading device 235 receives information that may be used to identify the consumer's payment account and/or transaction data at the associate system 206 and communicates the information via the communication device 236 over a network 201, to other systems such as, but not limited to the interaction intelligence server 208 and/or the user device 204. As such, the communication device 236 generally comprises a modem, server, or other device for communicating with other devices on the network 201.

As further illustrated in FIG. 1, the associate system 206 comprises computer-readable instructions 242 stored in the memory device 240, which in one embodiment includes the computer-readable instructions 242 of a channel application 244.

In the embodiment illustrated in FIG. 1, the channel application 244 allows the associate system 206 to be linked to the interaction intelligence server 208 and user device 204 to communicate, via a network 201, the information related to the user communication with the associate. In some embodiments the channel application 244 may identify a user 202 by user authorization at the reader device 235. In some embodiments, the channel application 244 may identify the user 202 based on associate or user 202 input.

In this way, the channel application 244 may identify that a communication has been initiated between the user 202 and the associate at an entity physical location. Furthermore, the channel application 244 may store information associated with the date, time, channel, disposition, and the like associated with the communication in the memory device 240.

The portable associate device 205 may be associated with and communicate directly with the associate system 206. The portable associate device 205 may be a portable device, such as a tablet or the like that the associate 203 may carry with him/her in the lobby of the entity or financial institution.

The associate 203 may be one or more individuals that are working with or for the entity at an entity location to aid a user 202 in communication and provide product/service information to the use 202.

As illustrated in FIG. 1, the system environment 200 further comprises an entity server 207. The entity server 207 is associated with the entity and may be directly linked to the associate system 206 and contain one or more associate systems 206. The entity server 207 comprises the same or similar devices as described above with respect to the interaction intelligence server 208, to the user device 204, and to the associate system 206. Furthermore, the entity server 207 is operatively coupled, via a network 201 to the user device 204, interaction intelligence server 208, and to the associate system 206. In this way, the entity server 207 can send information to and receive information from the user device 204, interaction intelligence server 208, and the associate system 206.

It is understood that the servers, systems, and devices described herein illustrate one embodiment of the invention. It is further understood that one or more of the servers, systems, and devices can be combined in other embodiments and still function in the same or similar way as the embodiments described herein.

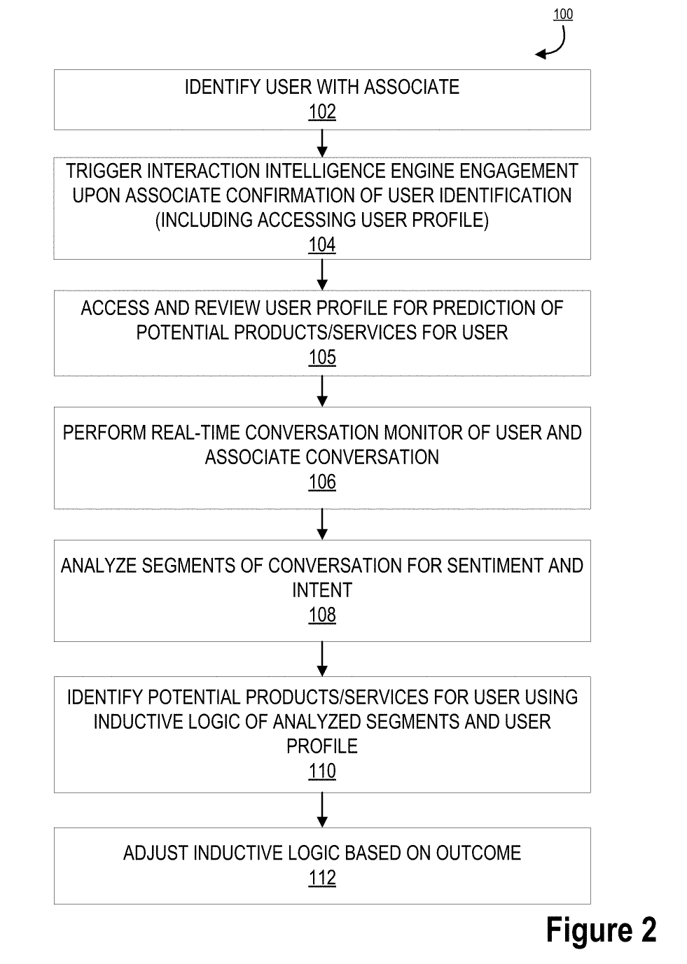

FIG. 2 illustrates a high level process flow illustrating interaction intelligence engine triggering for communication enhancement 100, in accordance with one embodiment of the present invention. As illustrated in block 102, the process 100 is initiated by identifying a user with an associate. The system may identify the user with the associate based on associate input, user profile generation on the associate device, user input, or the like.

As illustrated in block 104, the process 100 continues by triggering the interaction intelligence engine engagement based on associate confirmation of the user identification and accessing the user profile. The associate may confirm the user identification based on debit card and PIN authentication, username and password authentication, or the like. The associate may then select and access a profile for the user, which may include the accounts of the user, information about the user, and the like.

Next, as illustrated in block 105, the process 100 continues by accessing and reviewing the user profile for prediction of the potential products/services for the user. In this way, the interaction intelligence engine may simultaneously review the user profile while the associate is also viewing the user profile while speaking with the user. The system may review the user profile to potentially identify one or more products/services that the user may be interested in based on the user profile, including the user geographic location, age, income, demographics, children, or the like. The system, using the user profile, may identify financial products or services that the user may be interested in for development and utilization.

As illustrated in block 106, the interaction intelligence server is triggered to perform real-time conversation monitoring of the user and associate conversation. The monitoring includes voice recognition and segment recognition for identification of key segments, words, or the like that may trigger an identification of a product/service that may be predicted for the user. The monitoring includes a voice recognition software element that does not store the conversation, but instead identifies key words or segments that indicate a product/service.

Next, as illustrated in block 108, the process 100 continues by analyzing the segments of the voice recognition of the conversation for sentiment and intent of the user. In this way, the interaction intelligence server may identify the communication of the user and associate to identify segments of the conversation that indicate sentiment and intent of the user with respect to financial products or services that may be provided to the user by the entity and associate.

As illustrated in block 110, the process 100 continues by identifying potential products and/or services for the user from a financial institution using inductive logic of analyzed segments of the user and associate conversation and the user profile. In this way, the interaction intelligence server reviews the user profile in combination with the segments of the user and associate conversation to identify potential products/services that the user may desire based on predictive machine learning analytical analysis.

Finally, as illustrated in block 112, the process 100 is completed by adjusting the inductive logic based on user acceptance or denial based on the outcome of the product/service provided to the user. In this way, upon identification of the potential products/services for the user based on inductive logic of the analyzed segments of communication and the user profile, the associate may present the predicted potential products/services identified by the interactive intelligence server to the user for a decision. Upon decision of the user, the system may adjust the inductive logic of the products/services based on the user conversation and profile.

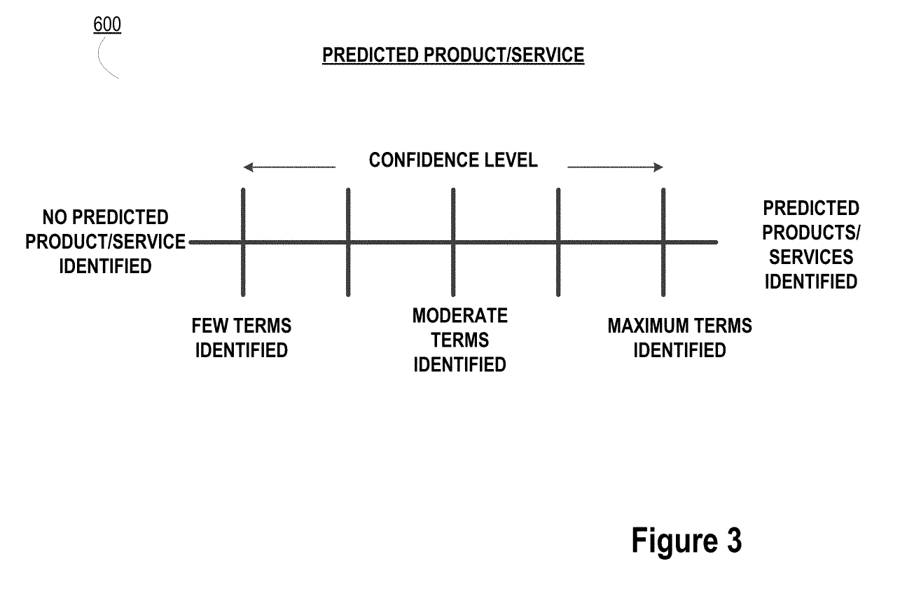

FIG. 3 provides a continuum mapping for product/service identification for communication enhancement 600, in accordance with one embodiment of the present invention. In this way, the interaction intelligence server may utilize a confidence level continuum to identify potential predicted products/services for the user based on the analyzing of the segments of the conversation between the user and the associate of the entity. On the left-hand side of the continuum, a “no predicted product/service identified” is triggered when the conversation between the user and the associate identifies no products/services of the entity that the user may be interested in based on the conversation. On the continuum, this point is where the least products/services for the user are identified. On the right-hand side of the continuum, a “predicted products/services identified” indicates when multiple products/services are identified during the user and associated communication. In between the two extremes, the system may identify few terms, moderate number of terms, or maximum number of terms identified between the conversation between the user and the associate to identify user terms indicative of one or more products/services that the user may be interested.

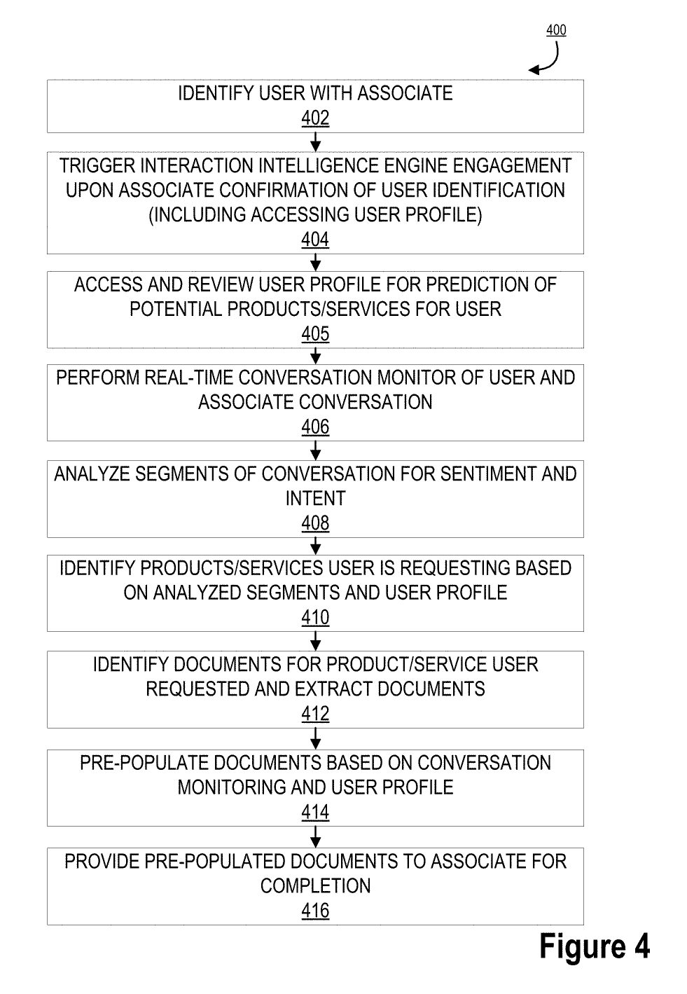

FIG. 4 provides a high level process flow illustrating interaction intelligence engine triggering for product/service document fulfillment 400, in accordance with one embodiment of the present invention. As illustrated in block 402, the process 400 is initiated by identifying a user with an associate. The system may identify the user with the associate based on associate input, user profile generation on the associate device, user input, or the like.

As illustrated in block 404, the process 400 continues by triggering the interaction intelligence engine engagement based on associate confirmation of the user identification and accessing the user profile. The associate may confirm the user identification based on debit card and PIN authentication, username and password authentication, or the like. The associate may then select and access a profile for the user, which may include the accounts of the user, information about the user, and the like.

Next, as illustrated in block 405, the process 400 continues by accessing and reviewing the user profile for prediction of the potential products/services for the user. In this way, the interaction intelligence engine may simultaneously review the user profile while the associate is also viewing the user profile while speaking with the user. The system may review the user profile to potentially identify one or more products/services that the user may be interested in based on the user profile, including the user geographic location, age, income, demographics, children, or the like. The system, using the user profile, may identify financial products or services that the user may be interested in for development and utilization.

As illustrated in block 406, the interaction intelligence server is triggered to perform real-time conversation monitoring of the user and associate conversation. The monitoring includes voice recognition and segment recognition for identification of key segments, words, or the like that may trigger an identification of a product/service that may be predicted for the user. The monitoring includes a voice recognition software element that does not store the conversation, but instead identifies key words or segments that indicate a product/service.

Next, as illustrated in block 408, the process 400 continues by analyzing the segments of the voice recognition of the conversation for sentiment and intent of the user. In this way, the interaction intelligence server may identify the communication of the user and associate to identify segments of the conversation that indicate sentiment and intent of the user with respect to financial products or services that may be provided to the user by the entity and associate.

As illustrated in block 410, the process 400 continues by identifying potential products and/or services that the use requested during the communication between the user and the associate based identification of the user requesting a product/service based on analyzed segments of the user and associate conversation.

Next, as illustrated in block 412, the process 400 continues by identifying documents for the products/services the user requested based on the identified products/services the user is requesting from the analyzed segments of the conversation between the user and the associate. The interaction intelligence server may further extract the documents necessary for user enrollment into the products/services that the user has requested based on the analytics.

As illustrated in block 414, the process 400 continue by pre-populating documents based on the conversation monitoring and user profile. In this way, the system identifies the products/services the user requests and subsequently identify one or more segments within the user conversation and the user profile to pre-populate documents associated with the products/services that are requested by the user.

Finally, as illustrated in block 416, the process 400 continues by providing the pre-populated documents to the associate for completion between the associate and the user. In this way, the pre-populated locations on the document may be confirmed by the user and the associate and the additional non pre-populated areas of the documents may be filled in by the user and the associate during the discussion and communication between the user and the associate.

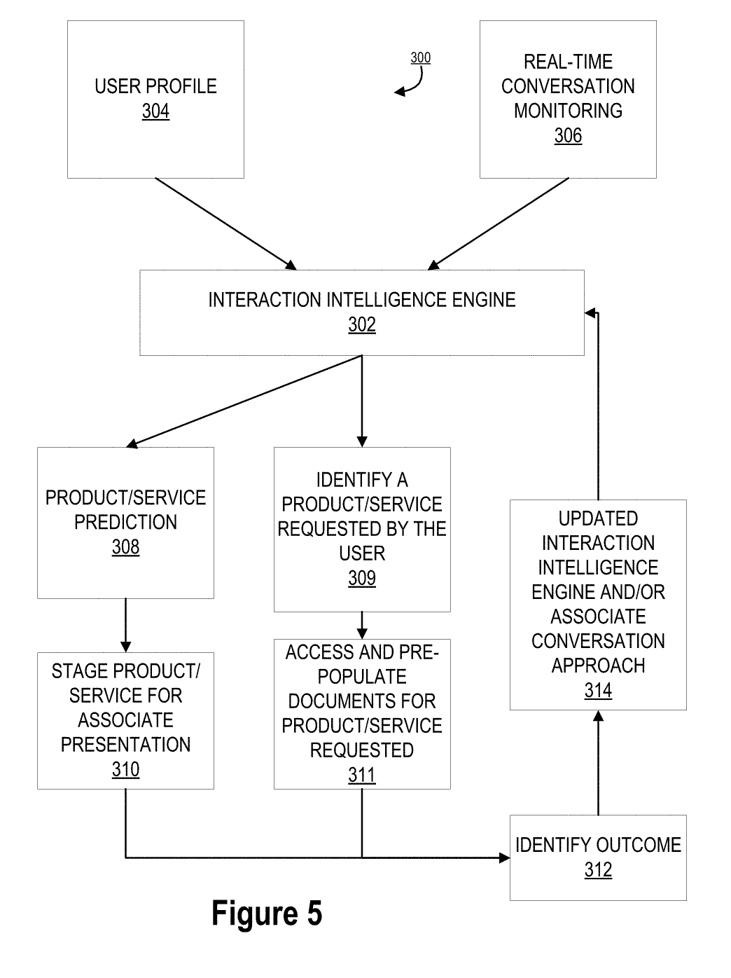

FIG. 5 provides a process map illustrating interaction intelligence engine triggering for communication enhancement and fulfillment 300, in accordance with one embodiment of the present invention. As illustrated, the interaction intelligence engine 302, may receive or extract data from a user profile 304 and/or real-time conversation monitoring 306.

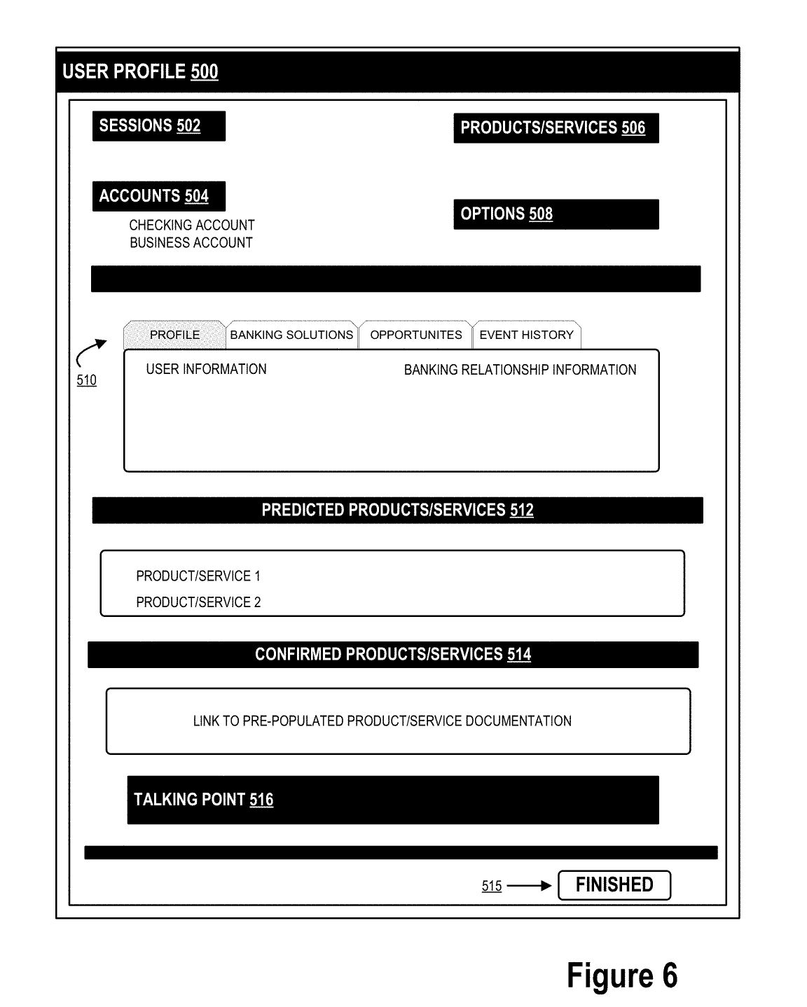

In some embodiments, a user profile 304 may comprise information about the user and the user interaction with the entity. FIG. 6 illustrates an embodiment of a user profile 500, in accordance with one embodiment of the present invention. As illustrated in FIG. 6, the user profile 500 may be presented to an associate prior to or at initiation of the user communication. At section 502 the sessions associated with that user are presented. There may be one or more sessions the user may have had within the last day/week/month. This section 502 also allows the associate to search the sessions and communications that a user has had previously. Next, as illustrated in section 504, the accounts the user has with the financial institution are displayed. These accounts may include one or more checking accounts, savings accounts, credit cards, loans, mortgages, lines of credit, or the like. Section 506 provides the associate with the top products/services as determined by the interaction intelligence engine as predicted product/service opportunities for the user. As such, top opportunities may products or services based on terms the user uses during the communication with the associate, past user transactions, communications, life events, or the like stemming from the user profile. Finally, section 508 illustrates an options category, allowing for various options with respect to the user profile 500 and updating of the same. These options include agent verification, commitment, opening a new account, refreshing a profile, providing maintenance, setting future appointments for the user, sales tools, general tools, inquiry tools, opportunities management, and recent user options.

As further illustrated in FIG. 6, section 510 of the user profile 500 includes the interface's main screen functions and tabs. These include viewing the user profile, banking solutions for the user, opportunities for the user, and event history for the user. The profile section may include user information, such as the title, address, and other contact information associated with the user. This profile also includes bank relationship information such as how long the user has been a bank user, the party identification, relationship manager, total balances, accounts, and/or other information that the user may have in affiliations with the financial institution. Banking solutions include any solutions that the system has developed based on past user communications or transactions. For example, a solution may stem from a recent telephone call the user made to a call center. The associate may follow up with solutions for that prior call to the call center. Opportunities will link back to the products/services that the financial institution may have available for the user. Finally, the event history tab provides a quick view of the most recent events of the user. These events may include any events that are added as user event data. The event history tab may also disclose the time, date, disposition, and the like associated with the one or more recent events for the user.

Next, as illustrated in section 512, the user profile 500 may include a pop up indicator with predicted products/services 512 based on the user provide 500 and the real-time conversation monitoring. The pop up a quick view of the products/services that may be predicted for the user based on the user provide 500 and the real-time conversation monitoring.

As illustrated in section 514, the user profile 500 may also include a pop up indicator with the confirmed products/services the user requests. These confirmed products/services are identified based on the monitoring of the user and associate conversation. The interaction intelligence server may identify the documents required for the products/services and pre-populate those documents for prevention of typing errors or the like by the user. As such, a link to the pre-populated documents is provided within the confirmed products/services section 514.

As illustrated in section 516, there may be a talking point that the associate may start the communication with the user. This talking point may be presented directly to the associate via the user profile interface, such that the associate may initiate the user communication with the talking point. Finally, when the communication is complete, the agent may select the finish button 515 to exit out of the user profile 500.

Referring back to FIG. 5, the interaction intelligence engine may, in some embodiments, perform real-time conversation monitoring 306. In this way, the interaction intelligence engine 302 may trigger a monitoring of the conversation of the user and associate. The monitoring includes voice recognition and segment recognition for identification of key segments, words, or the like that may trigger an identification of a product/service for the user. The monitoring includes a voice recognition software element that does not store the conversation, but instead identifies key words or segments that indicate a product/service. The interaction intelligence engine 302 may analyze the segments of the voice recognition of the conversation for sentiment and intent of the user. In this way, the interaction intelligence server may identify the communication of the user and associate to identify segments of the conversation that indicate sentiment and intent of the user with respect to financial products or services that may be provided to the user by the entity and associate.

In some embodiments, using the conversation monitoring and user profile, the interaction intelligence engine 302 may predict products/services the user may be interested in, as illustrated in block 308. As illustrated in block 310, once the interaction intelligence engine identifies predicted products/services that the user may be interested in, the system may stage the product/service for associate presentation to the user. This staging may be a pop up indication on the user profile, a pop up triggered on the associate computer device, or the like.

In some embodiments, using the conversation monitoring and user profile, the interaction intelligence engine 302 may identify products/services that the user requests during the communication, as illustrated in block 309. Once the product/service is identified as being requested by the user, the system may access any documents required to register the user with the product/service and pre-populate the documents using the user profile and/or the terms or segments identified by the interaction intelligence engine during the real-time communication monitoring.

As illustrated in block 311, once the system identified the products/services that are being requested by the user, the system may access and pre-populate documents for the products/services requested.

Next, as illustrated in block 312, the system may follow up after the user and associate communication to identify the outcome of the presented predicted product/service from block 310 or the presented pre-populated documents for products/services in block 311. If the user accepted one or more of the products/services the system may update the machine learning algorithm of the interaction intelligence engine with that outcome for improvement of future associate communications with various users. Furthermore, if the user denies one or more of the products/services the system may update the machine learning algorithm of the interaction intelligence engine with that outcome for improvement of future associate communications with various users. As illustrated in block 314, the interaction intelligence engine is updated and/or the associate conversation approach may be updated or modified.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more general-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for communication enhancement and fulfillment, the system comprising:
a memory device with computer-readable program code stored thereon;
a communication device;
a processing device operatively coupled to the memory device and the communication device, wherein the processing device is configured to execute the computer-readable program code to:
identify a user in communication with an associate;
trigger presentation of a user profile associated with the user to the associate, wherein the presentation of the user profile is triggered based on the identification of the user in communication with the associate;
perform real-time conversation monitoring of user and associate conversation;
analyze segments of conversation for sentiment and intent, wherein upon analysis the segments of the conversation are discarded and not stored;
identify one or more products/services for the user based on the sentiment and intent of the user via analyzing of the segments of the conversation;
deploy, in real-time, the one or more products/services identified to the associate via the user profile, for associate presentation of the one or more products/services to the user;
confirm user interest in the one or more products/services for the user; and
extract and pre-populate documents associated with sign up for the one or more products/services for the user and present the pre-populated documents to the associate.

2. The system of claim 1, wherein extracting and pre-populating documents associated with sign up for the one or more products/services for the user further comprises utilizing the segments of the conversation and the user profile for pre-populating documents for error prevention of document generation.

3. The system of claim 1, further comprising presenting the one or more products/services to the associate for communication of the one or more products/services to the user and identifying the outcome of the presenting of the one or more products/services for adjustment of inductive logic for analyzing of the segments of the conversation.

4. The system of claim 1, wherein identifying one or more products/services for the user based on the sentiment and intent of the user via analyzing of the segments of the conversation further comprises identifying one or more products/services the user is intending to sign up for and identifying one or more products/services that are predicted for the user based on the sentiment and intent of the user via analyzing of the segments of the conversation and the user profile.

5. The system of claim 1, wherein identifying the user in communication with the associate further comprises identifying the user at a physical location of an entity in communication with the associate.

6. The system of claim 1, wherein identifying the user in communication with the associate further comprises authenticating the user at an entity location.

7. The system of claim 1, wherein presenting the user profile to the associate further comprises authenticating the user associated with the user profile prior to presenting the user profile to the associate, the authentication occurs via geo-fence identification, personal identification number (PIN), magnetic strip swiping of financial institution card, or password authentication, wherein the user profile provides an interface which includes information about recent user events, accounts the user has with an entity, products/services available to the user from the entity, user status information, and entity solutions for the user communications.

8. The system of claim 1, wherein the user profile is adapted to be presented to the agent at a communication channel associated with an entity, when the user communicates with the associate, such that the associate has immediate access to information about the user via the user profile.

9. A computer program product for communication enhancement and fulfillment, the computer program product comprising at least one non-transitory computer-readable medium having computer-readable program code portions embodied therein, the computer-readable program code portions comprising:
an executable portion configured for identifying a user in communication with an associate;
an executable portion configured for triggering presentation of a user profile associated with the user to the associate, wherein the presentation of the user profile is triggered based on the identification of the user in communication with the associate;
an executable portion configured for performing real-time conversation monitoring of user and associate conversation;
an executable portion configured for analyzing segments of conversation for sentiment and intent, wherein upon analysis the segments of the conversation are discarded and not stored;
an executable portion configured for identifying one or more products/services for the user based on the sentiment and intent of the user via analyzing of the segments of the conversation;
an executable portion configured for deploying, in real-time, the one or more products/services identified to the associate via the user profile, for associate presentation of the one or more products/services to the user;
an executable portion configured for confirming user interest in the one or more products/services for the user; and
an executable portion configured for extracting and pre-populating documents associated with sign up for the one or more products/services for the user and present the pre-populated documents to the associate.

10. The computer program product of claim 9, wherein extracting and pre-populating documents associated with sign up for the one or more products/services for the user further comprises utilizing the segments of the conversation and the user profile for pre-populating documents for error prevention of document generation.

11. The computer program product of claim 9, further comprising an executable portion configured for presenting the one or more products/services to the associate for communication of the one or more products/services to the user and identifying the outcome of the presenting of the one or more products/services for adjustment of inductive logic for analyzing of the segments of the conversation.

12. The computer program product of claim 9, wherein identifying one or more products/services for the user based on the sentiment and intent of the user via analyzing of the segments of the conversation further comprises identifying one or more products/services the user is intending to sign up for and identifying one or more products/services that are predicted for the user based on the sentiment and intent of the user via analyzing of the segments of the conversation and the user profile.

13. The computer program product of claim 9, wherein identifying the user in communication with the associate further comprises identifying the user at a physical location of an entity in communication with the associate.

14. The computer program product of claim 9, wherein identifying the user in communication with the associate further comprises authenticating the user at an entity location.

15. The computer program product of claim 9, wherein presenting the user profile to the associate further comprises authenticating the user associated with the user profile prior to presenting the user profile to the associate, the authentication occurs via geo-fence identification, personal identification number (PIN), magnetic strip swiping of financial institution card, or password authentication, wherein the user profile provides an interface which includes information about recent user events, accounts the user has with an entity, products/services available to the user from the entity, user status information, and entity solutions for the user communications.

16. The computer program product of claim 9, wherein the user profile is adapted to be presented to the agent at a communication channel associated with an entity, when the user communicates with the associate, such that the associate has immediate access to information about the user via the user profile.

17. A computer-implemented method for communication enhancement and fulfillment, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
identifying a user in communication with an associate;
triggering presentation of a user profile associated with the user to the associate, wherein the presentation of the user profile is triggered based on the identification of the user in communication with the associate;
performing real-time conversation monitoring of user and associate conversation;
analyzing segments of conversation for sentiment and intent, wherein upon analysis the segments of the conversation are discarded and not stored;
identifying one or more products/services for the user based on the sentiment and intent of the user via analyzing of the segments of the conversation;
deploying, in real-time, the one or more products/services identified to the associate via the user profile, for associate presentation of the one or more products/services to the user;
confirming user interest in the one or more products/services for the user; and
extracting and pre-populating documents associated with sign up for the one or more products/services for the user and present the pre-populated documents to the associate.

18. The computer-implemented method of claim 17, wherein extracting and pre-populating documents associated with sign up for the one or more products/services for the user further comprises utilizing the segments of the conversation and the user profile for pre-populating documents for error prevention of document generation.

19. The computer-implemented method of claim 17, further comprising presenting the one or more products/services to the associate for communication of the one or more products/services to the user and identifying the outcome of the presenting of the one or more products/services for adjustment of inductive logic for analyzing of the segments of the conversation.

20. The computer-implemented method of claim 17, wherein identifying one or more products/services for the user based on the sentiment and intent of the user via analyzing of the segments of the conversation further comprises identifying one or more products/services the user is intending to sign up for and identifying one or more products/services that are predicted for the user based on the sentiment and intent of the user via analyzing of the segments of the conversation and the user profile.
